(19) United States
(12) Patent Application Publication
(10) Pub. No.: US 2018/0209139 A1
(43) Pub. Date: Jul. 26, 2018

(54) COMBINED ANCHOR AND REBAR ASSEMBLY AND METHOD FOR PRODUCING THE SAME

(71) Applicant: SHEHKAI PRECISION CO., LTD., Kaohsiung City (TW)

(72) Inventor: Tai-Yuan TU, Kaohsiung City (TW)

(21) Appl. No.: 15/868,156

(22) Filed: Jan. 11, 2018

Related U.S. Application Data
(62) Division of application No. 15/622,685, filed on Jun. 14, 2017.

(30) Foreign Application Priority Data
Jan. 25, 2017 (TW) 106102797

(51) Int. Cl. E04B 1/41; B23K 31/02; E04C 5/16; B21H 3/02; B21K 1/46; E04G 21/12

(52) U.S. Cl. CPC E04B 1/4157; B23K 31/022; E04G 21/12; B21H 3/02; B21K 1/46; E04C 5/163

(57) ABSTRACT

A combined anchor and rebar assembly includes a rebar, a bolt head, an anchor bolt and a weld joint. The bolt head is formed integrally as one piece with an end of the rebar. The anchor bolt includes a threadless portion and a threaded portion. The threaded portion has a diameter smaller than that of the threadless portion and is formed with a screw thread. The weld joint joins another end of the rebar to the threadless portion in a manner that the rebar and the threadless portion are aligned along an axial line. The weld joint has a cross section larger than that of the threadless portion and projects radially from the rebar and the threadless portion. A method of producing the combined anchor and rebar assembly is also disclosed.

### CROSS-REFERENCE TO RELATED APPLICATION

The Application claims benefit from and is a divisional application of U.S. patent application Ser. No. 15/622,685 filed Jun. 14, 2017 entitled COMBINED ANCHOR AND REBAR ASSEMBLY AND METHOD OF PRODUCING THE SAME, which claims priority to Taiwanese Patent Application No. 106102797, filed on Jan. 25, 2017, which applications are hereby incorporated by reference in their entirety.

### FIELD

The disclosure relates to a combined anchor and rebar assembly and a method of producing the combined anchor and rebar assembly for being planted into a concrete structure.

### BACKGROUND

Referring to FIG. 1, there is shown an existing combined anchor and rebar assembly 1 suitable for being planted into a concrete structure 10. The concrete structure 10 has a preformed hole 101. The combined anchor and rebar assembly 1 includes an anchor bolt 11, a rebar 12 and a join unit 13. The anchor bolt 11 includes a bolt head 111, a threaded shank 112 extending from the bolt head 111 and formed with a screw thread 110, and an inner threaded groove 113 formed in the bolt head 111. The threaded shank 112 is screwed into the preformed hole 101 through the screw thread 110. The bolt head 111 is disposed on an outer surface of the concrete structure 10 above the performed hole 101. The join unit 13 is formed on an end of the rebar 12, and includes a threaded connection member 131 to be screwed into the inner threaded groove 113.

To complete the combined anchor and rebar assembly 1, the inner threaded groove 113 has to be formed in the bolt head 111 by tapping, and the threaded connection member 131 of the joint unit 13 has to be formed in conformity to the inner threaded groove 113. During the operation of planting the combined anchor and rebar assembly 1, the anchor bolt 11 is first secured in the preformed hole 101, and the rebar 12 is thereafter screwed into the threaded connection 131 to fix the rebar 12 to the anchor bolt 11. The operation is therefore complicated.

### SUMMARY

Therefore, one object of the disclosure is to provide a combined anchor and rebar assembly that can be planted easily into a structure.

According to one aspect of the disclosure, a combined anchor and rebar assembly includes a rebar, a rebar head, an anchor bolt and a weld joint.

The rebar has a rebar rod with two opposite first and second ends.

The rebar head is formed integrally as one piece with the first end of the rebar rod.

The anchor bolt includes a shank body having a threadless portion and a threaded portion. The threaded portion has a diameter smaller than that of the threadless portion and is formed with a screw thread.

The weld joint joins the second end of the rebar rod to the threadless portion in a manner that the rebar and the threadless portion are aligned along an axial line. The weld joint has a cross section larger than that of the threadless portion and projects radially from the rebar and the threadless portion.

Another object of the disclosure is to provide a method for producing a combined anchor and rebar assembly.

According to another aspect of the disclosure, a method for producing a combined anchor and rebar assembly includes:

providing a rebar having a rib pattern;

providing an anchor bolt, the anchor bolt including a shank body having a threadless portion and a threaded portion, the threadless portion having a diameter larger than a diameter of the threaded portion, the threaded portion being formed with a screw thread; and

providing a welded joint for joining the threadless portion of the anchor bolt to the rebar such that the rebar and the anchor bolt are aligned along an axial line, the welded joint having a cross section larger than that of the rebar and the threadless portion.

### BRIEF DESCRIPTION OF THE DRAWINGS

Other features and advantages of the disclosure will become apparent in the following detailed description of the embodiments with reference to the accompanying drawings, of which:

FIG. 1 illustrates an existing combined anchor and rebar assembly;

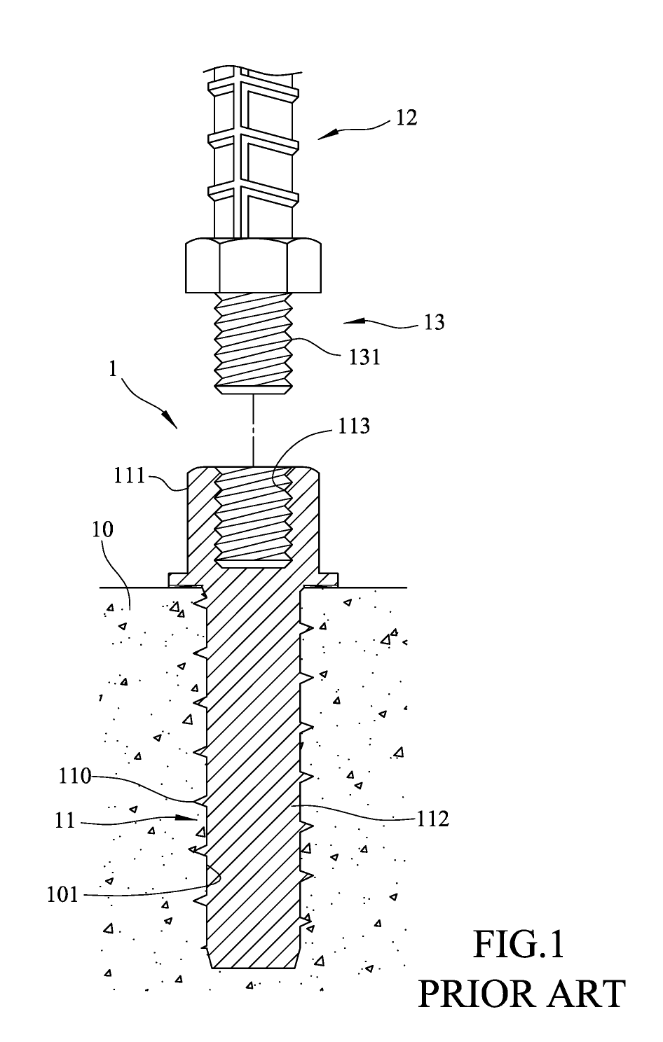

FIG. 2 illustrates a combined anchor and rebar assembly according to an embedment of the present disclosure;

FIG. 3 illustrates the combined anchor and rebar assembly of the embedment and a concrete structure with a preformed hole;

FIG. 4 is a sectional view of the embodiment;

FIG. 5 illustrates a method of producing a combined anchor and rebar assembly according to the first embodiment the present disclosure;

FIG. 6 illustrates a method of producing a combined anchor and rebar assembly according to the second embodiment the present disclosure;

FIG. 7 illustrates a method of producing a combined anchor and rebar assembly according to the third embodiment the present disclosure;

FIG. 8 illustrates a method of producing a combined anchor and rebar assembly according to the fourth embodiment the present disclosure;

FIG. 9 illustrates a method of producing the combined anchor and rebar assembly according to the fifth embodiment the present disclosure;

FIG. 10 illustrates the combined anchor and rebar assembly of the present disclosure planted into a concrete structure; and

FIG. 11 illustrates that a building structure is constructed on the concrete structure through the combined anchor and rebar assembly.

### DETAILED DESCRIPTION

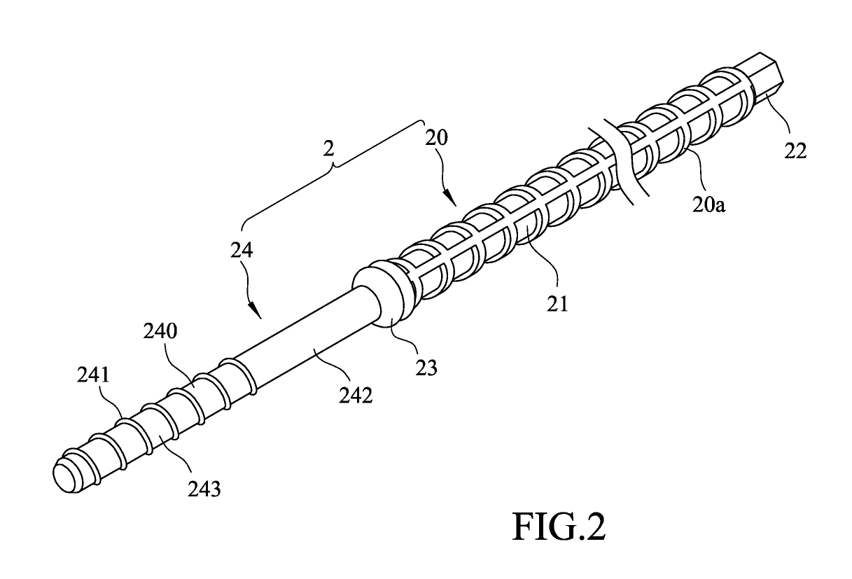

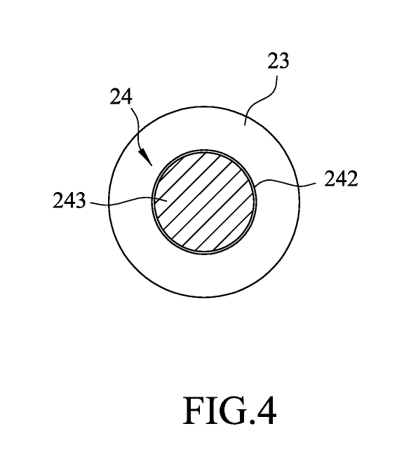

Referring to FIGS. 2 to 4, a combined anchor and rebar assembly 2 according to an embodiment of the present disclosure includes a rebar 20, a rebar head 22, an anchor bolt 24 and a weld joint 23.

The rebar 20 has a rebar rod 21 with two opposite first and second ends, and a rib pattern 20a formed on the rebar rod 21.

The rebar head 22 is formed integrally as one piece with the first end of the rebar rod 21.

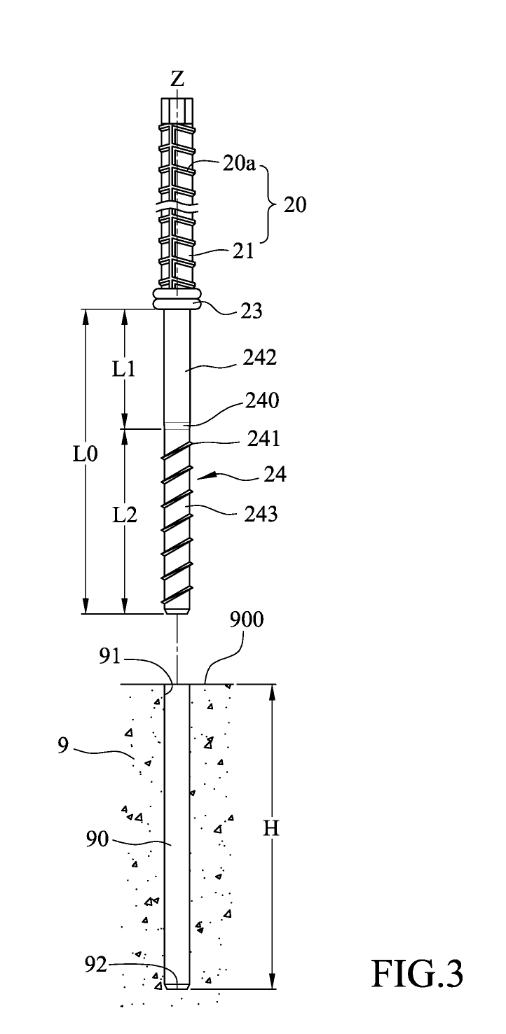

The anchor bolt 24 includes a shank body 240 having a threadless portion 242 and a threaded portion 243. The threaded portion 243 has a diameter smaller than that of the threadless portion 242 and is formed with a screw thread 241. As shown in FIG. 3, the threadless portion 242 has a length (L1) smaller than a length (L2) of the threaded portion 243.

The weld joint 23 joins the second end of the rebar rod 21 to the threadless portion 242 in a manner that the rebar 20 and the threadless portion 242 are aligned along an axial line (Z). The weld joint 23 has a cross section larger than that of the threadless portion 242 and projects radially from the rebar 20 and the threadless portion 242. In this embodiment, the weld joint 23 has two disk-shaped weld portions projecting in all radial directions from the rebar 20 and the threadless portion 242. The two disk-shaped weld portions of the weld joint 23 are superimposed on one another.

The combined anchor and rebar assembly 2 is suitable for being planted into a concrete structure 9. The concrete structure includes an outer surface 900, an inner surface 91, and a bottom surface 92. The outer surface 900, the inner surface 91 and the bottom surface 92 cooperatively define a preformed hole 90 with a performed depth (H) between the outer and bottom surfaces 900, 92.

A method for producing the combined anchor and rebar assembly 2 generally includes: providing the rebar 20; providing the anchor bolt 24; and providing the welded joint 23 for joining the anchor blot 24 to the rebar 20.

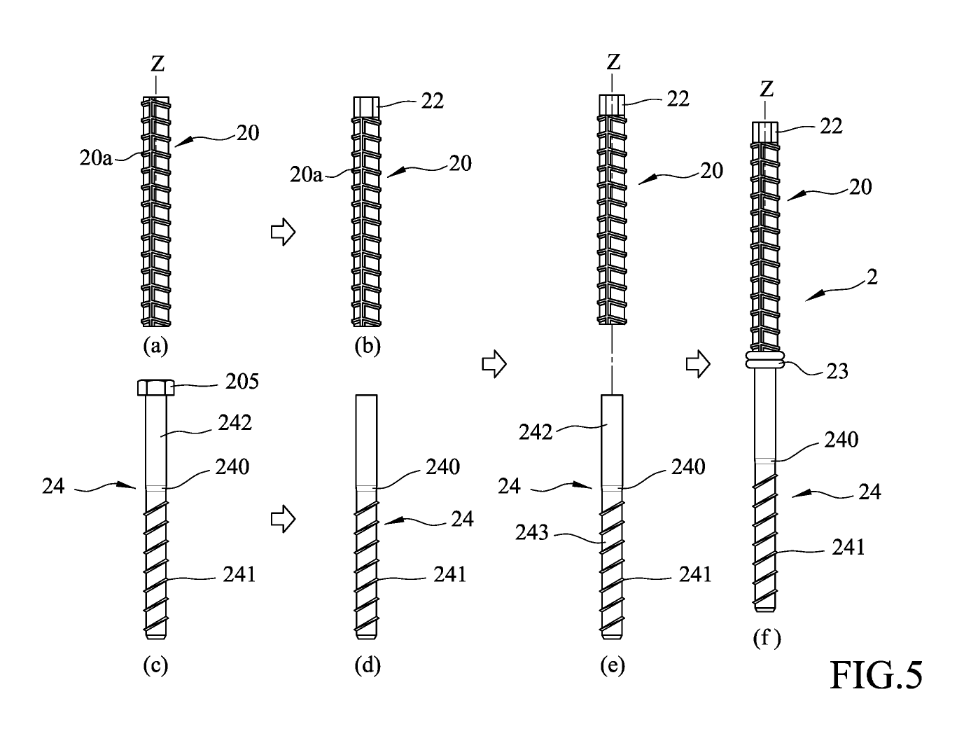

Referring to FIG. 5, consecutive steps of the method for producing the combined anchor and rebar assembly 2 according to a first embodiment of the disclosure are illustrated. In step (a), the rebar 20 having the rib pattern 20a is prepared. In step (b), one end of the rebar 20 is formed into the rebar head 22 by a forging process. In step (c), the anchor bolt 24 is prepared. The anchor bolt 24 in this embodiment is a ready-made existing bolt and thus has the bolt head 205 connected to the threadless portion 242 of the shank body 240. In step (d), the bolt head 205 is cut off from the shank body 240. In step (e), the rebar 20 and the anchor bolt 24 are aligned along an axial line (Z). In step (f), the threadless portion 242 of the anchor bolt 24 is welded to the rebar 20 to provide the welded joint 23 such that the rebar 20 and the anchor bolt 24 are jointed together and aligned along the axial line (Z). The welded joint 23 has a cross section larger than that of the rebar 20 and the threadless portion 242.

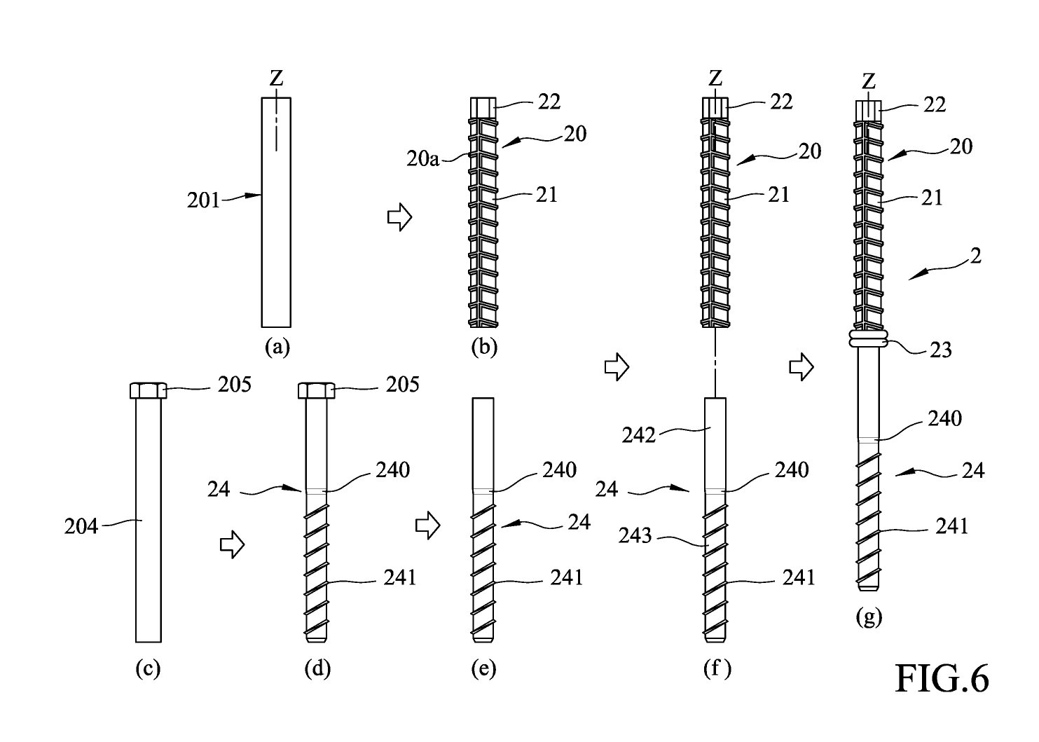

Referring to FIG. 6, consecutive steps of the method for producing the combined anchor and rebar assembly 2 according to a second embodiment of the disclosure are illustrated. In step (a), a rebar blank 201 is prepared. In step (b), the rebar blank 201 is formed into the rebar 20 having the rib pattern 20a through a rolling process, and a rebar head 22 is formed by forging one end of the rebar 20. In step (c), a bolt blank 204 having a bolt head 205 is prepared. In step (d), the bolt blank 204 is formed into the anchor bolt 24 through a thread rolling process. In step (e), the bolt head 205 is cut off from the shank body 240. In step (f), the rebar 20 and the anchor bolt 24 are aligned along an axial line (Z). In step (g), the threadless portion 242 of the anchor bolt 24 is welded to the rebar 20 to provide the welded joint 23 such that the rebar 20 and the anchor bolt 24 are aligned along the axial line (Z). The welded joint 23 has a cross section larger than that of the rebar 20 and the threadless portion 242.

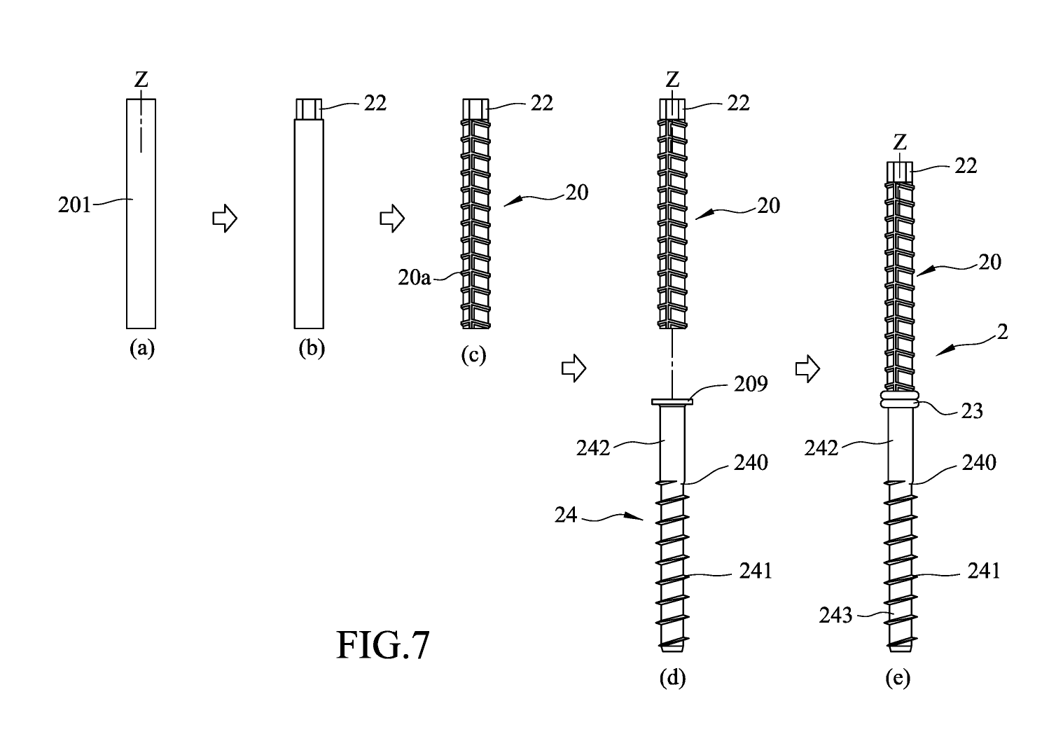

Referring to FIG. 7, consecutive steps of the method for producing the combined anchor and rebar assembly 2 according to a third embodiment of the disclosure are illustrated. In step (a), a rebar blank 201 is prepared. In step (b), one end of the rebar blank 201 is formed into the rebar head 22 through a forging process. In step (c), the rebar blank 201 is formed into the rebar 20 with the rib pattern 20a through a rolling process. In step (d), the rebar 20 is aligned with the anchor bolt 24. The threadless portion 242 of the anchor bolt 24 in this embodiment has an enlarged end-flange 209. In step (e), the threadless portion 242 of the anchor bolt 24 is welded to the rebar 20 to provide the welded joint 23 such that the rebar 20 and the anchor bolt 24 are aligned along the axial line (Z). During the welding of the threadless portion 242 to the rebar 20, the enlarged end-flange 209 is welded to the rebar 20. The welded joint 23 provided in this embodiment has an increased cross section compared to those formed in the first and second embodiments. As the anchor bolt 24 is free of the bolt head 205, no cutting step is necessary for the anchor bolt 24.

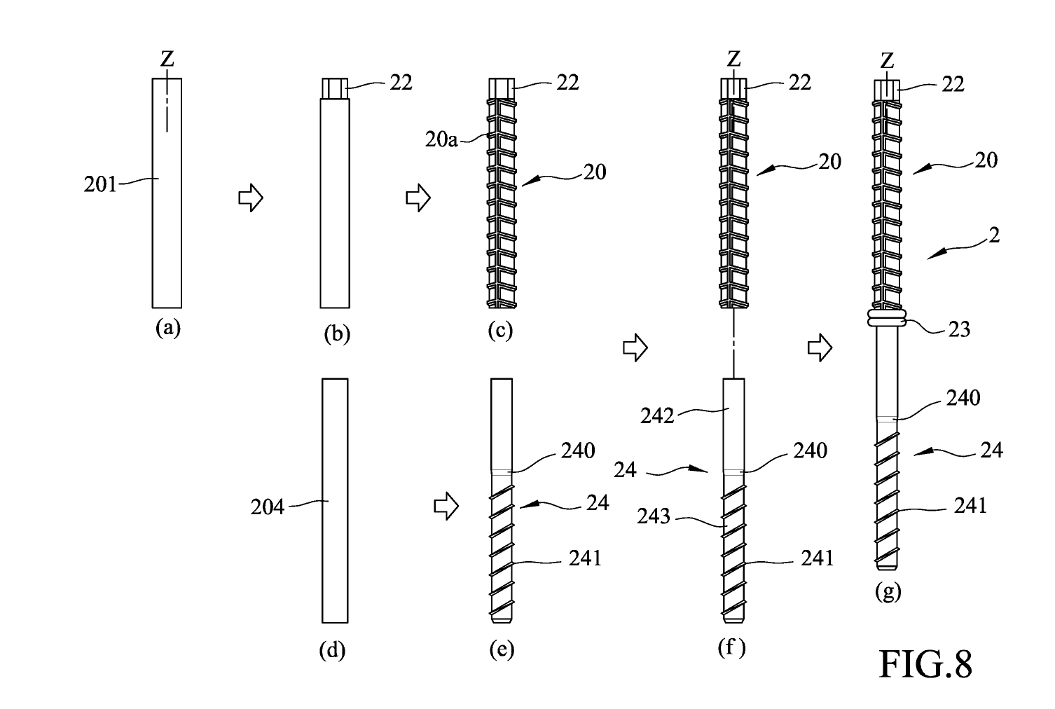

FIG. 8 illustrates consecutive steps of the method for producing the combined anchor and rebar assembly 2 according to a fourth embodiment of the disclosure. In step (a), a rebar blank 201 is provided. In step (b), one end of the rebar blank 201 is formed into the rebar head 22 through a forging process. In step (c), the rebar blank 201 is formed into the rebar 20 having the rib pattern 20a through a rolling process. In step (d), a bolt blank 204 is provided. In step (e), the bolt blank 204 is formed into the anchor bolt 24 through a rolling process. In step (f), the rebar 20 is aligned with the anchor bolt 24. In step (g), the threadless portion 242 of the anchor bolt 24 is welded to the rebar 20 to provide the welded joint 23 such that the rebar 20 and the anchor bolt 24 are aligned along the axial line (Z). As the anchor bolt 24 is free of the bolt head 205, no cutting step is necessary for the anchor bolt 24.

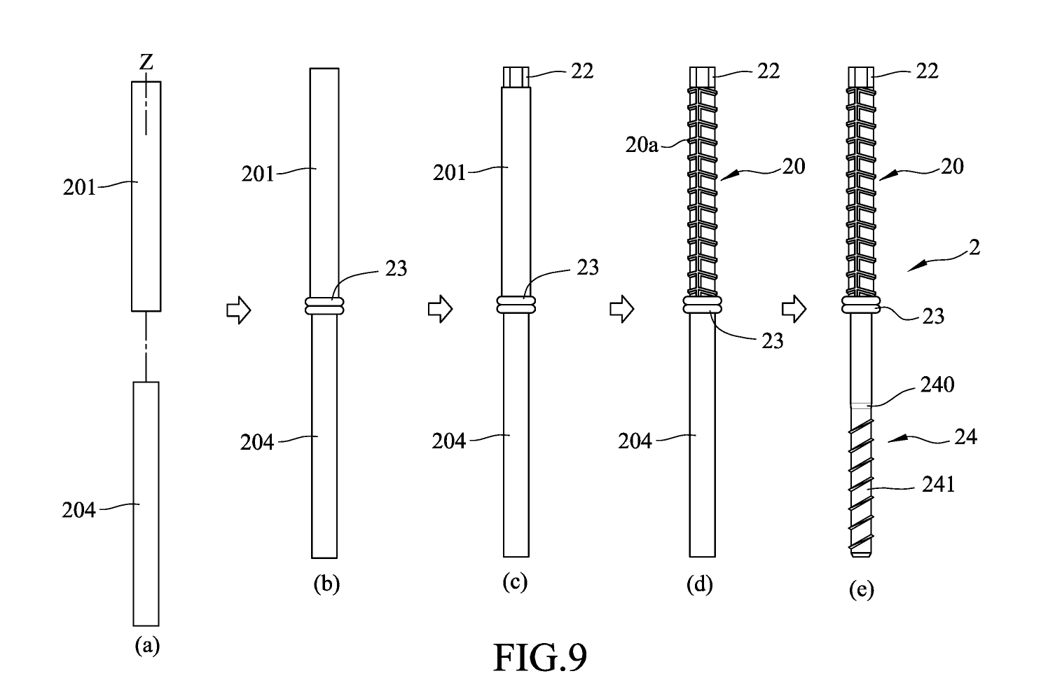

FIG. 9 illustrates consecutive steps of the method for producing the combined anchor and rebar assembly 2 according to a fifth embodiment of the disclosure. In step (a), a rebar blank 201 and a bolt blank 204 are prepared and aligned along an axial line (Z). In step (b), one end of the rebar blank 201 is welded to one end of the bolt blank 204 to provide the welded joint 23. In step (c), another end of the rebar blank 201 is formed into the rebar head 22 through a forging process after the welded joint 23 is formed. In step (d), the rebar blank 201 is formed into the rebar 20 with the rib pattern 20a through a rolling process after the welded joint 23 is formed. In step (e), the bolt blank 204 is formed into the anchor bolt 24 through a rolling process after the welded joint 23 is formed. In this embodiment, the welded joint 23 is provided by welding the bolt blank 204 to the rebar blank 201 before the rebar blank 201 is formed into the rebar 21 and before the bolt blank 204 is formed into the anchor bolt 24.

During the producing of the combined anchor and rebar assembly 2, the welded joint 23 is formed from the weld flash resulting from the welding of the anchor bolt 24 to the rebar 20. The position of the weld joint 23 may be used to indicate a length (LO) of the anchor bolt 24 conforming to the depth (H) to which the anchor bolt 24 extends within the preformed hole 90. Thus, the weld flash is not removed through any additional process, thereby saving the fabrication cost.

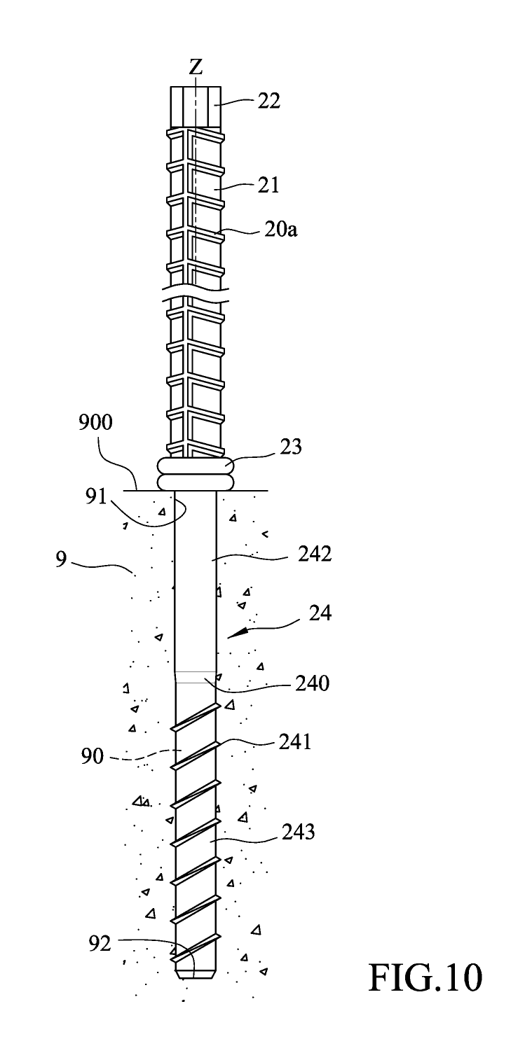

Referring to FIG. 10, during the securing of the combined anchor and rebar assembly 2 into the preformed hole 90, the bolt head 22 is rotated to drive rotation of the anchor bolt 24 about the axial line (Z). The screw thread 241 cuts into the inner surface 91 of the concrete structure 9 to advance the threaded portion 243 into the preformed hole 90, and the threadless portion 242 is subsequently advanced into the preformed hole 90. Due to the diameter of the threadless portion 242 is larger than that of the threaded portion 243, the threadless portion 242 abuts radially and tightly against the inner surface 91. By virtue of the diameter of the threadless portion 242 larger than that of the threaded portion 243, the structural strength of the anchor bolt 24 can be enhanced. When the weld joint 23 abuts against the outer surface 900 of the concrete structure 9, the weld joint 23 is at the top open end of the preformed hole 90. This may indicate that the anchor bolt 24 reaches the bottom surface 92 of the concrete structure 9 and may also ensure that the anchor bolt 24 is actually locked in the performed hole 90. Further, because the weld joint 23 has the cross section larger than that of the rebar 21 and the threadless portion 242, the weld joint 23 is able to cover the top open end of the preformed hole 90 and provide an abutment force against the concrete structure 9, which enhances stability of the combined anchor and rebar assembly 2.

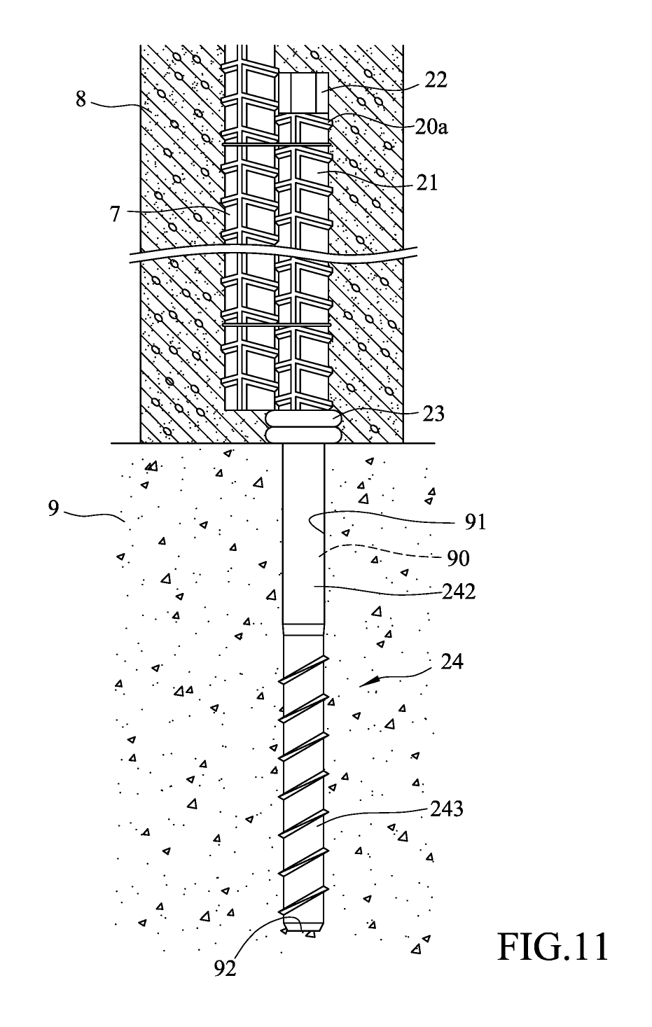

Referring to FIG. 11, after the combined anchor and rebar assembly 2 is secured to the concrete structure 9, the rebar 20 is connected with another rebar 7 for subsequent construction of a building structure 8. Because of the high securing stability of the combined anchor and rebar assembly 2 on the structure 9, the building structure 8 reinforced by the rebar 7 which is connected to the combined anchor and rebar assembly 2 can be strengthened.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for producing a combined anchor and rebar assembly, comprising:
providing a rebar having a rib pattern;
providing an anchor bolt, the anchor bolt including a shank body having a threadless portion and a threaded portion, the threadless portion having a diameter larger than a diameter of the threaded portion, the threaded portion being formed with a screw thread; and
providing a welded joint for joining the threadless portion of the anchor bolt to the rebar such that the rebar and the anchor bolt are aligned along an axial line, the welded joint having a cross section larger than that of the rebar and the threadless portion.

2. The method as claimed in claim 1, wherein providing the welded joint includes welding the threadless portion to the rebar.

3. The method as claimed in claim 2, wherein providing the rebar includes forging one end of the rebar to form a rebar head.

4. The method as claimed in claim 2, wherein the anchor bolt further has a bolt head connected as one piece with the threadless portion, the method further comprising cutting off the bolt head from the threadless portion before providing a welded joint.

5. The method as claimed in claim 2, wherein the threadless portion has an enlarged-end flange, and wherein the enlarged-end flange is welded to the rebar during welding the threadless portion to the rebar.

6. The method as claimed in claim 2, wherein providing an anchor bolt includes preparing a bolt blank, and thread rolling the bolt blank to form the screw thread.

7. The method as claimed in claim 1, wherein the threadless portion has a length smaller than a length of the threaded portion.

8. The method as claimed in claim 2, wherein providing a rebar includes preparing a rebar blank, forming the rebar blank into the rebar by a rolling process, and forging one end of the rebar blank to form the rebar head.

9. The method as claimed in claim 2, wherein providing an anchor bolt includes preparing a bolt blank, and forming the bolt blank into the anchor bolt by a rolling process.

10. The method as claimed in claim 1, wherein:
providing a rebar includes preparing a rebar blank, and forming the rebar blank into the rebar by a rolling process;
providing an anchor bolt includes preparing a bolt blank, and forming the bolt blank into the anchor bolt by a rolling process; and
providing a welded joint includes welding the bolt blank to the rebar blank before forming the rebar blank into the rebar and before forming the bolt blank into the anchor bolt.
